(19) United States
(12) Patent Application Publication
(10) Pub. No.: US 2007/0005721 A1
(43) Pub. Date: Jan. 4, 2007

(54) Remotable porting layer

(75) Inventors: Peter T. Barrett, Palo Alto, CA (US); Tim C. Nichols, Los Altos, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/172,396

(22) Filed: Jun. 30, 2005

(51) Int. Cl. G06F 15/16

(52) U.S. Cl. 709/217

(57) ABSTRACT

Remotable porting layer is described. In an embodiment, a porting layer remotes an embedded application to a computing system platform that is different than a computing system platform for which the embedded application was developed. The porting layer includes a communications protocol that receives data communications from the embedded application via IP-addressable ports of a socket-based interface. The porting layer can transfer the data communications to any of a graphic component, an event component, or a state information component of the computing system platform which processes the data communications according to the computing system platform and hardware configuration.

### BACKGROUND

Device-specific applications and embedded systems are developed taking into account the hardware configuration and/or the operating system of the device that the application or embedded system is being developed for. For example, an embedded client system can be developed to operate on a specific platform of a television-based client device. As such, the device-specific embedded system can be difficult to “port”, or implement, in another television-based client device that has a different platform and/or hardware configuration. When porting an embedded client system to another platform, an integrator of the differing platform typically requires the source code of the client system, or a binary file of the client system that was generated with a tool chain of the target platform. This can lead to having to disclose the source code, having a need for familiarity with the tool chain of the target platform, and/or the resources to build the binary file of the embedded client system.

### SUMMARY

This summary is provided to introduce simplified concepts of remotable porting layer which is further described below in the Detailed Description. This summary is not intended to identify essential features of the claimed subject matter, nor is it intended for use in determining the scope of the claimed subject matter.

In an embodiment of remotable porting layer, a porting layer remotes an embedded application to a computing system platform that is different than a computing system platform for which the embedded application was developed. The porting layer includes a communications protocol that receives data communications from the embedded application via IP-addressable ports of a socket-based interface. The porting layer can transfer the data communications to any of a graphic component, an event component, or a state information component of the computing system platform which processes the data communications according to the computing system platform and hardware configuration.

### BRIEF DESCRIPTION OF THE DRAWINGS

The same numbers are used throughout the drawings to reference like features and components.

FIG. 1 illustrates an exemplary computing environment in which embodiments of remotable porting layer can be implemented.

FIG. 2 illustrates an alternate exemplary computing environment in which embodiments of remotable porting layer can be implemented.

FIG. 3 illustrates an alternate exemplary computing environment in which embodiments of remotable porting layer can be implemented.

FIG. 4 illustrates an exemplary method for remotable porting layer.

FIG. 5 illustrates various components of an exemplary television-based client device in which embodiments of remotable porting layer can be implemented.

FIG. 6 illustrates various devices and components in an exemplary entertainment and information system in which embodiments of remotable porting layer can be implemented.

### DETAILED DESCRIPTION

Remotable porting layer is described in which embodiments provide techniques to remote and integrate a device-specific application, such as an embedded client system, that was developed for a different computing platform and/or hardware configuration. In a specific embodiment, an embedded client application developed to operate in a television-based client device can be remoted to a platform of a different television-based client device. A porting layer abstracts specific implementations of the remote platform and can be implemented as a referenced component (e.g., a dynamic linked library), as a separate process running on the same device as the device-specific application, or on a different device as a remote process.

An embedded client application can be remoted such that an integrator of the target device need only write to the porting layer that implements the communication protocol. The embedded client application can then make function calls via the porting layer to perform the platform dependent operations. Additionally, the embedded client application can be remoted without having to provide the source code of the client system which the embedded client application was developed for, and without a binary file of the client system that is generated with a tool chain of the target platform.

While aspects of the described systems and methods for remotable porting layer can be implemented in any number of different computing systems, environments, television-based entertainment systems, and/or configurations, embodiments of remotable porting layer are described in the context of the following exemplary system architectures.

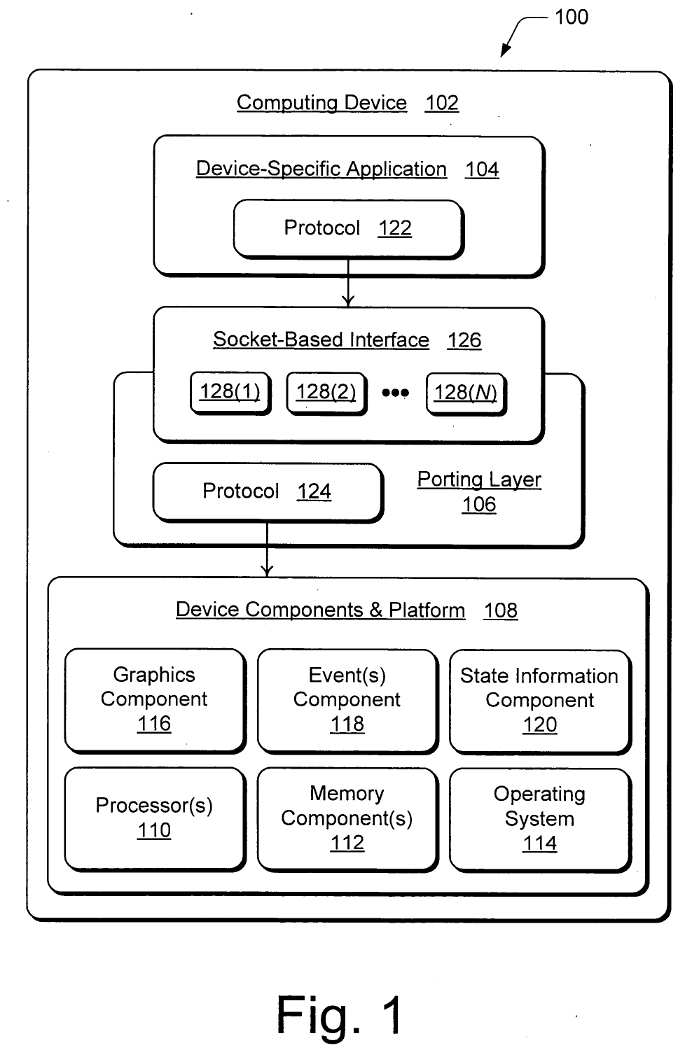

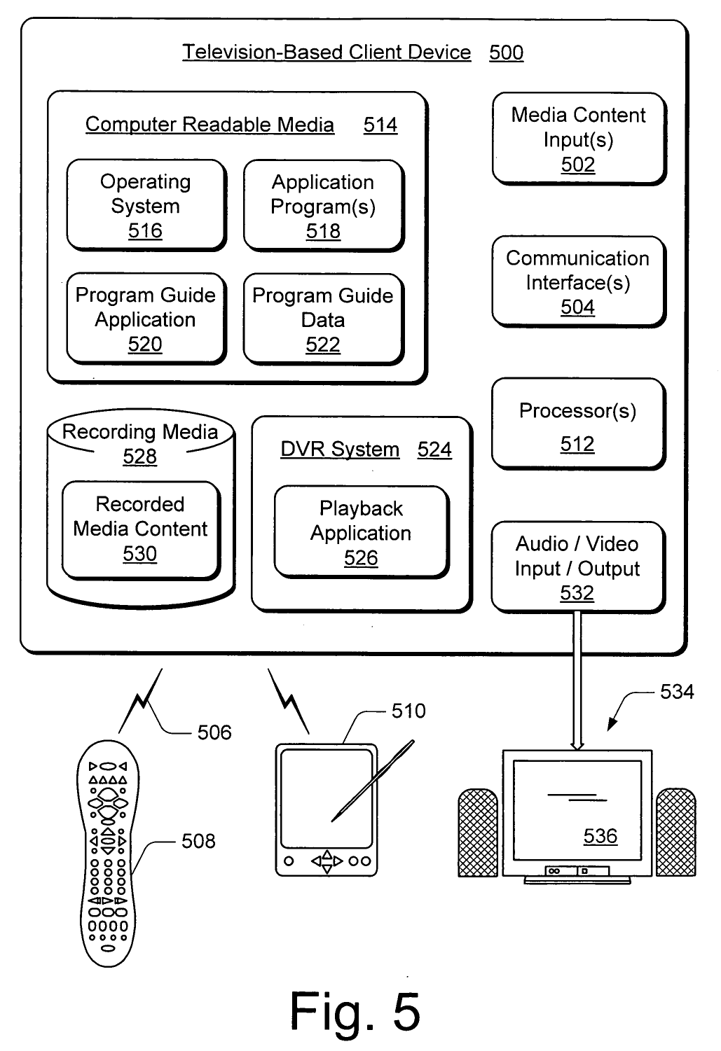

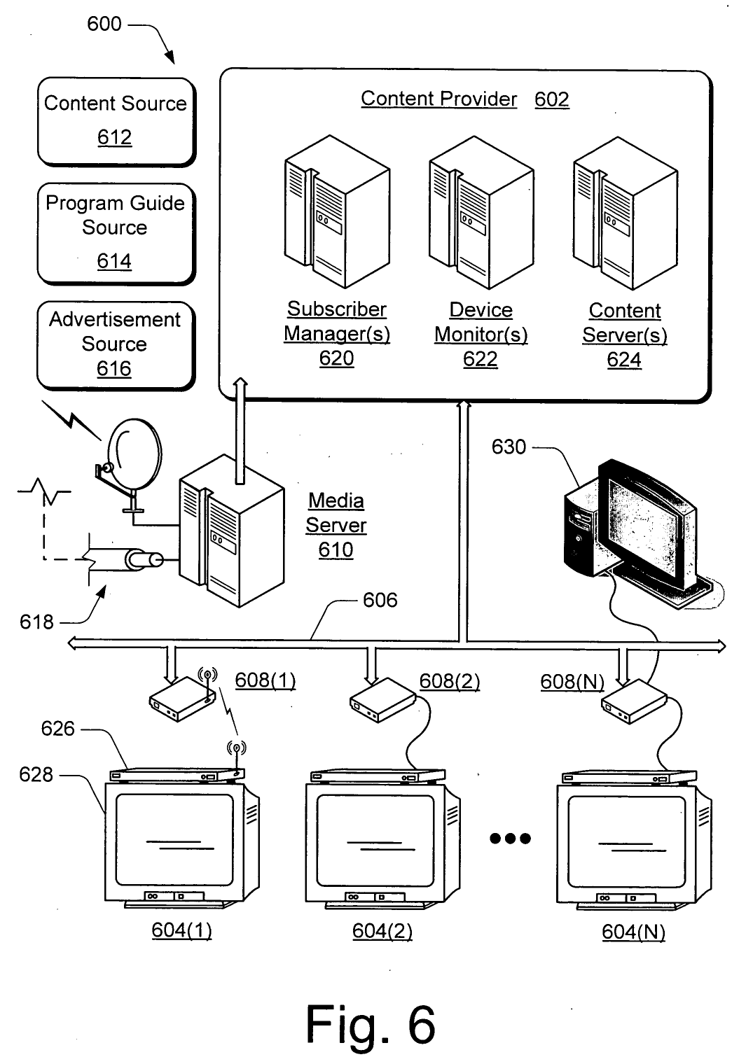

FIG. 1 illustrates an exemplary computing environment 100 in which embodiments of remotable porting layer can be implemented. In environment 100, a computing device 102 includes a device-specific application 104, a porting layer 106, and various device components and system platform 108. The computing device 102 can be implemented in any number of embodiments, such as a set-top box, a digital video recorder (DVR) and playback system, an appliance device, a gaming system, or as any other type of computing or client device. Additionally, the computing device 102 can be implemented with any one or combination of the components described with reference to the television-based client device 500 shown in FIG. 5, and can be implemented in the exemplary television-based system 600 described with reference to FIG. 6.

The device-specific application 104 can be an embedded application developed for another computing device having a different platform and/or hardware configuration. For example, the device-specific application 104 may be an embedded client application developed for a television-based client device to implement the television-based client device in an IP-based television system, such as the television-based system 600 described with reference to FIG. 6. The embedded client application (e.g., device-specific application 104) can then be remoted to computing device 102 with porting layer 106 which abstracts specific implementations of the computing device 102.

In this example, the various device components and system platform 108 of computing device 102 includes one or more processors 110, memory component(s) 112, and an operating system 114. The processor(s) 110 can be implemented as any of microprocessors, controllers, and the like which process various computer executable instructions to control the operation of computing device 102. The memory component(s) 112 can be implemented as any form of computer readable media to maintain software applications, such as the device-specific application 104 and the operating system 114 which can be executed on the processor(s) 110 to implement embodiments of remotable porting layer. In this implementation, the porting layer 106 is implemented as an independent process, or local host, on the computing device platform 108 to integrate the device-specific application 104 with the platform 108 of computing device 102.

Computing device 102 includes various components 108 to process data communications generated by the device-specific application 104. In this example, computing device 102 can be implemented as a television-based client device and include a graphics component 116, an event(s) component 118, and a state information component 120 all of which may be implemented as software, hardware, firmware, or any combination thereof.

The device-specific application 104 implements a communication protocol 122, as does the porting layer 106 implement the communication protocol at 124. The device-specific application 104 communicates data communications to the porting layer 106 according to the communication protocol 122, 124. The data communications are routed via a socket-based interface 126 that includes any number of IP-addressable ports 128(1-N). The data communications from the device-specific application 104 can include graphics, events, and/or state information data communications which may be independently addressable via the IP-addressable ports 128(1-N) of the socket-based interface 126.

The device-specific application protocol 122 and the porting layer protocol 124 include a protocol for the graphics, events, and state information and are utilized to communicate the data communications between the two. With remotable porting layer, the porting layer 106 can be written to port the device-specific application 104. A managed client application (e.g., the device-specific application 104) can be configured for which IP-addressable ports 128(1-N) of the socket-based interface 126 are used for the various data communications, such as the graphics and events. Additionally, the client code of the device-specific application 104 does not need to be recompiled, nor does a pre-built binary file need to be provided for the target device when the porting layer 106 remotes the device-specific application 104.

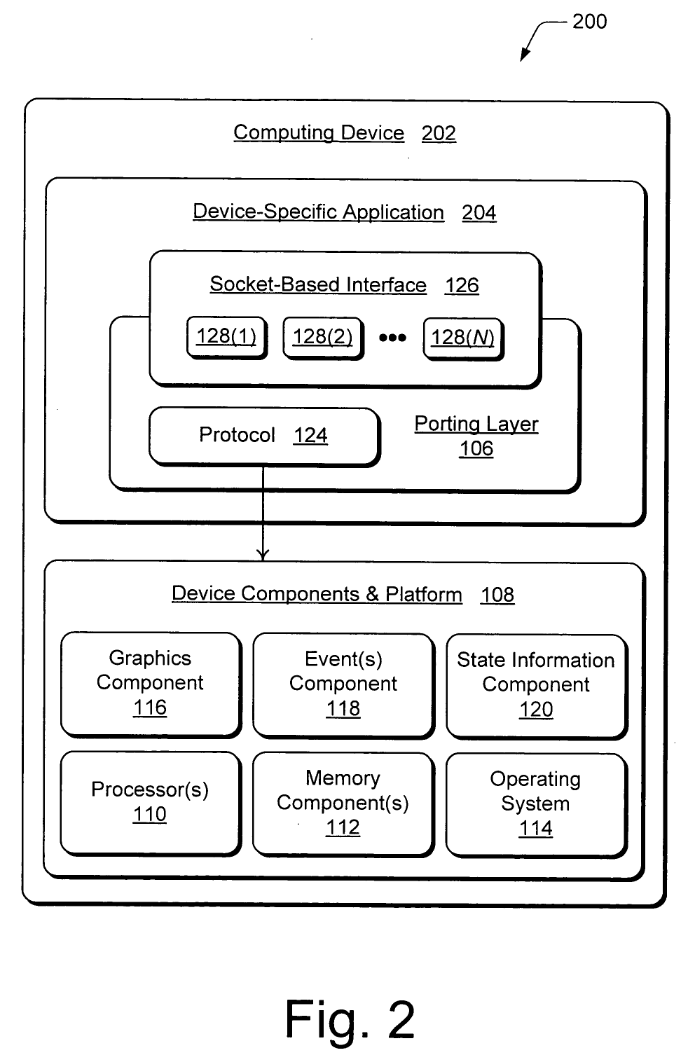

FIG. 2 illustrates an alternate exemplary computing environment 200 in which embodiments of remotable porting layer can be implemented. In environment 200, a computing device 202 includes a device-specific application 204, and includes the various device components and system platform 108 as described with reference to the exemplary computing environment 100 shown in FIG. 1. In an embodiment, the computing device 202 can be implemented with any one or combination of the components described with reference to the television-based client device 500 shown in FIG. 5, and can be implemented in the exemplary television-based system 600 described with reference to FIG. 6.

In an embodiment, the device-specific application 204 can be an embedded client application developed for a television-based client device to implement the television-based client device in an IP-based television system, such as the television-based system 600 described with reference to FIG. 6. The embedded client application (e.g., device-specific application 204) can then be remoted to computing device 202 with porting layer 106 which abstracts specific implementations of the computing device 202. In this example, the porting layer 106 can be implemented as a referenced component of the device-specific application 204. In an embodiment as a referenced component, the porting layer 106 can be implemented as a dynamic linked library that executes as a module, or component, of the device-specific application 204.

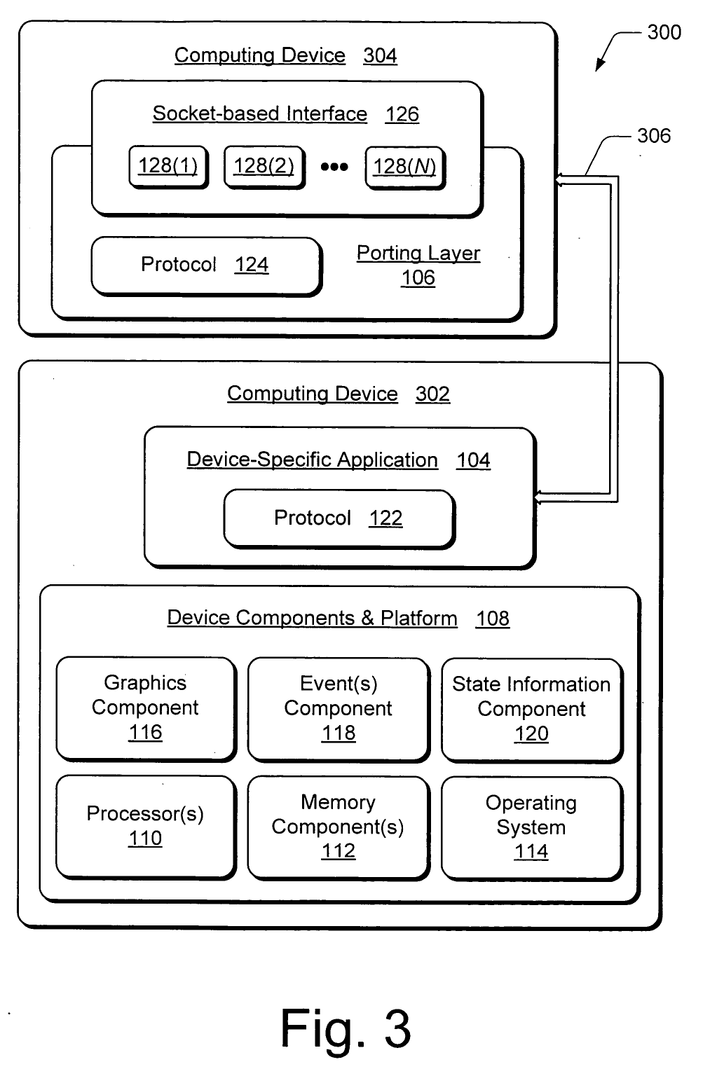

FIG. 3 illustrates an alternate exemplary computing environment 300 in which embodiments of remotable porting layer can be implemented. The environment 300 includes a first computing device 302 that includes the device-specific application 104, and the environment 300 includes a second computing device 304 that is configured for communication with computing device 302 via a communication network 306. In this example, the remote computing device 304 (i.e., “remote” from computing device 302 and the device-specific application 104) includes the porting layer 106 and the socket-based interface 126 as described with reference to the exemplary computing environment 100 shown in FIG. 1.

The porting layer 106 is executed at remote computing device 304 as a remote process to integrate the device-specific application 104 with computing device 302. Additionally, as the remote process in computing device 304, the porting layer 106 can be implemented to remote the device-specific application 104 on more than one additional device platforms.

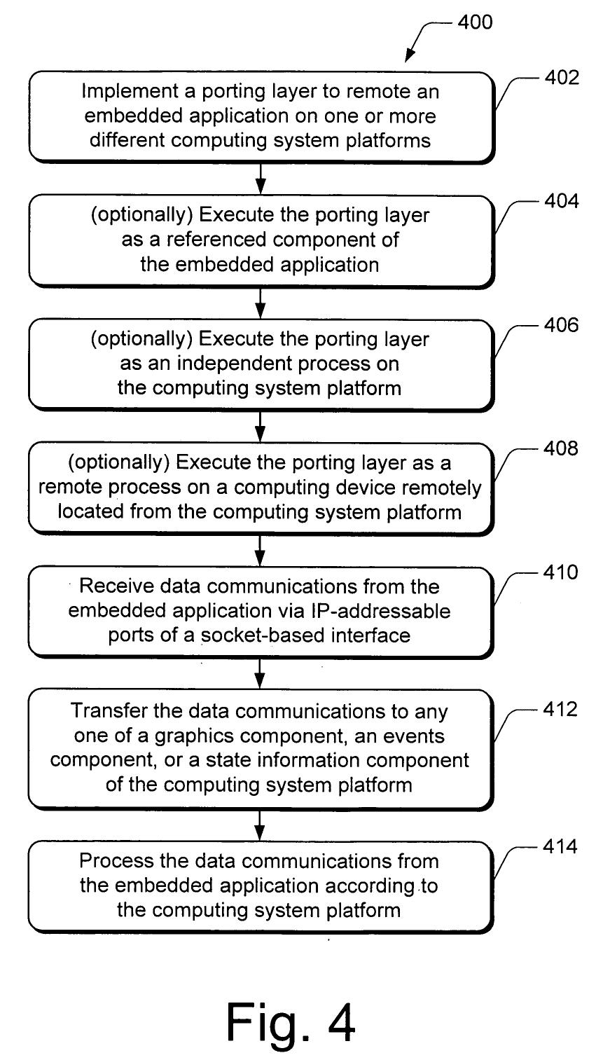

Methods for remotable porting layer, such as exemplary method 400 described with reference to FIG. 4, may be described in the general context of computer executable instructions. Generally, computer executable instructions can include routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

FIG. 4 illustrates an exemplary method 400 for remotable porting layer, and is described with reference to the exemplary computing environments 100, 200, and 300 shown in respective FIGS. 1, 2, and 3. The order in which the method is described is not intended to be construed as a limitation, and any number of the described method blocks can be combined in any order to implement the method. Furthermore, the method can be implemented in any suitable hardware, software, firmware, or combination thereof.

At block 402, a porting layer is implemented to remote an embedded application on one or more different computing system platforms. For example, porting layer 106 remotes the device-specific application 104 (e.g., an embedded application) onto platform 108 in computing device 102 as shown in FIG. 1, where the device-specific application 104 was developed for a different computing system platform. Similarly, porting layer 106 (FIG. 2) remotes the device-specific application 204 onto platform 108 in computing device 202, and porting layer 106 (FIG. 3) in remote computing device 304 remotes the device-specific application 104 onto platform 108 in computing device 302.

At block 404, the porting layer is optionally executed as a referenced component of the embedded application. For example, porting layer 106 (FIG. 2) is implemented as a referenced component (e.g., a dynamic linked library) of the device-specific application 204 to integrate the device-specific application with the computing system platform 108 in computing device 202.

At block 406, the porting layer is optionally executed as an independent process on the computing system platform. For example, porting layer 106 (FIG. 1) is implemented as an independent process to integrate the device-specific application 104 with computing system platform 108 in computing device 102. At block 408, the porting layer is optionally executed as a remote process on a computing device remotely located from the computing system platform. For example, porting layer 106 (FIG. 3) is implemented as a remote process in a remote computing device 304 to integrate the device-specific application 104 with the computing system platform 108 in computing device 302.

At block 410, data communications are received from the embedded application via IP-addressable ports of a socket-based interface. For example, the device-specific application 104 (FIG. 1) includes a communication protocol 122 that communicates data communications via IP-addressable ports 128(1-N) of the socket-based interface 126 to a communication protocol 124 of the porting layer 106. The porting layer 106 can receive the data communications as any one or combination of graphics, events, and state information data communications which are independently addressable via the different IP-addressable ports 128(1-N) of the socket-based interface 126.

At block 412, the data communications are transferred from the porting layer to any one of a graphics component, an event component, or a state information component of the computing system platform. For example, the porting layer 106 (FIG. 1) receives the data communications from the device-specific application 104 via the socket-based interface 126, and transfers the data communications to any one or combination of the graphics component 116, event(s) component 118, or the state information component 120 of the computing system platform 108 in computing device 102.

At block 414, the data communications received from the embedded application are processed according to the computing system platform. For example, computing system platform 108 (FIG. 1) in computing device 102 processes the data communications received from the embedded application 104 (via the socket-based interface 126 and the porting layer 106) according to the configuration of the computing system platform 108 in computing device 102.

FIG. 5 illustrates various components of an exemplary television-based client device 500 in which embodiments of remotable porting layer can be implemented. The client device 500 can be implemented as any one or more of the electronic, computing, and client devices described herein. For example, client device 500 can be implemented with any number of the various components as computing devices 102, 202, and 302 in the exemplary computing environments described with reference to the respective FIGS. 1, 2, and 3.

Client device 500 includes one or more media content inputs 502 which may include Internet Protocol (IP) inputs over which streams of media content are received via an IP-based network (such as communication network 306 shown in FIG. 3). Device 500 further includes communication interface(s) 504 which can be implemented as any one or more of a serial and/or parallel interface, a wireless interface, any type of network interface, a modem, and as any other type of communication interface. A wireless interface enables device 500 to receive control input commands 506 and other information from an input device, such as from remote control device 508, PDA (personal digital assistant) 510, a cellular phone, or from another infrared (IR), 802.11, Bluetooth, or similar RF input device.

A network interface provides a connection between the television-based client device 500 and a communication network by which other electronic and computing devices can communicate data with device 500. Similarly, a serial and/or parallel interface provides for data communication directly between device 500 and the other electronic or computing devices. A modem facilitates device 500 communication with other electronic and computing devices via a conventional telephone line, a DSL connection, cable, and/or other type of connection.

Client device 500 also includes one or more processors 512 (e.g., any of microprocessors, controllers, and the like) which process various computer executable instructions to control the operation of device 500, to communicate with other electronic and computing devices, and to implement embodiments of remotable porting layer. Device 500 can be implemented with computer readable media 514, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer readable media 514 provides data storage mechanisms to store various information and/or data such as software applications and any other types of information and data related to operational aspects of client device 500. For example, an operating system 516 and/or other application programs 518 (e.g., the device-specific applications 104 and 204) can be maintained as software applications with the computer readable media 514 and executed on processor(s) 512 to implement embodiments of remotable porting layer.

For example, the computer readable media 514 includes a program guide application 520 that is implemented to process program guide data 522 and generate program guides for display which enable a viewer to navigate through an onscreen display and locate broadcast programs, recorded programs, video on-demand programs and movies, interactive game selections, and other media access information or content of interest to the viewer. The client device 500 can also include a DVR system 524 with playback application 526, and recording media 528 to maintain recorded media content 530.

The client device 500 also includes an audio and/or video output 532 that provides audio and video to an audio rendering and/or display system 534, or to other devices that process, display, and/or otherwise render audio, video, and display data. Video signals and audio signals can be communicated from device 500 to a television 536 via an RF (radio frequency) link, S-video link, composite video link, component video link, analog audio connection, or other similar communication link.

FIG. 6 illustrates an exemplary entertainment and information system 600 in which an IP-based television environment can be implemented, and in which embodiments of remotable porting layer can be implemented. System 600 facilitates the distribution of program content, program guide data, and advertising content to multiple viewers. System 600 includes a content provider 602 and television-based client systems 604(1-N) each configured for communication via an IP-based network 606.

The network 606 can be implemented as a wide area network (e.g., the Internet), an intranet, a Digital Subscriber Line (DSL) network infrastructure, or as a point-to-point coupling infrastructure. Additionally, network 606 can be implemented using any type of network topology and any network communication protocol, and can be represented or otherwise implemented as a combination of two or more networks. A digital network can include various hardwired and/or wireless links 608(1-N), routers, gateways, and so on to facilitate communication between content provider 602 and the client systems 604(1-N). The television-based client systems 604(1-N) receive program content, program guide data, advertising content, closed captions data, and the like from content server(s) of the content provider 602 via the IP-based network 606.

System 600 includes a media server 610 that receives program content from a content source 612, program guide data from a program guide source 614, and advertising content from an advertisement source 616. In an embodiment, the media server 610 represents an acquisition server that receives the audio and video program content from content source 612, an EPG server that receives the program guide data from program guide source 614, and/or an advertising management server that receives the advertising content from the advertisement source 616.

The content source 612, the program guide source 614, and the advertisement source 616 control distribution of the program content, the program guide data, and the advertising content to the media server 610 and/or to other television-based servers. The program content, program guide data, and advertising content is distributed via various transmission media 618, such as satellite transmission, radio frequency transmission, cable transmission, and/or via any number of other transmission media. In this example, media server 610 is shown as an independent component of system 600 that communicates the program content, program guide data, and advertising content to content provider 602. In an alternate implementation, media server 610 can be implemented as a component of content provider 602.

Content provider 602 is representative of a headend service in a television-based content distribution system, for example, that provides the program content, program guide data, and advertising content to multiple subscribers (e.g., the television-based client systems 604(1-N)). The content provider 602 can be implemented as a satellite operator, a network television operator, a cable operator, and the like to control distribution of program and advertising content, such as movies, television programs, commercials, music, and other audio, video, and/or image content to the client systems 604(1-N).

Content provider 602 includes various components to facilitate media data processing and content distribution, such as a subscriber manager 620, a device monitor 622, and a content server 624. The subscriber manager 620 manages subscriber data, and the device monitor 622 monitors the client systems 604(1-N) (e.g., and the subscribers), and maintains monitored client state information.

Although the various managers, servers, and monitors of content provider 602 (to include the media server 610 in one embodiment) are illustrated and described as distributed, independent components of content provider 602, any one or more of the managers, servers, and monitors can be implemented together as a multi-functional component of content provider 602. Additionally, any one or more of the managers, servers, and monitors described with reference to system 600 can implement features and embodiments of remotable porting layer.

The television-based client systems 604(1-N) can be implemented to include a client device 626 and a display device 628 (e.g., a television). A client device 626 of a television-based client system 604 can be implemented in any number of embodiments, such as a set-top box, a digital video recorder (DVR) and playback system, a personal video recorder (PVR), an appliance device, a gaming system, and as any other type of client device that may be implemented in a television-based entertainment and information system. In an alternate embodiment, client system 604(N) is implemented with a computing device 630 as well as a client device 626. Additionally, any of the client devices 626 of a client system 604 can implement features and embodiments of remotable porting layer as described herein.

Although embodiments of remotable porting layer have been described in language specific to structural features and/or methods, it is to be understood that the subject of the appended claims is not necessarily limited to the specific features or methods described. Rather, the specific features and methods are disclosed as exemplary implementations of remotable porting layer.

1. A computing system, comprising:
a device-specific application developed to execute on a first device platform, the device-specific application including a communications protocol for data communications;
a porting layer configured to remote the device-specific application to a second device platform that is configured to processes the data communications from the device-specific application differently than the first device platform is configured to process the data communications, the porting layer including the communications protocol to receive the data communications from the device-specific application; and
a socket-based interface configured to communicate the data communications from the device-specific application to the porting layer via IP-addressable ports.

2. A computing system as recited in 1, wherein the porting layer is implemented as a referenced component of the device-specific application to integrate the device-specific application with the second device platform.

3. A computing system as recited in 1, wherein the porting layer is implemented to execute as an independent process on the second device platform to integrate the device-specific application with the second device platform.

4. A computing system as recited in 1, further comprising:
a computing device that includes the second device platform and the device-specific application;
a remote computing device configured to execute the porting layer as a remote process to integrate the device-specific application with the second device platform; and
a communication network configured to couple the data communications between the device-specific application and the porting layer via the socket-based interface.

5. A computing system as recited in 1, wherein the data communications from the device-specific application include at least one of graphics, events, or state information data communications, and wherein each of the graphics, events, and state information data communications are independently addressable via the IP-addressable ports of the socket-based interface.

6. A computing system as recited in 1, wherein the porting layer is configured to execute as a local host to remote the device-specific application on the second device platform.

7. A computing system as recited in 1, wherein the porting layer is further configured to remote the device-specific application on more than one additional device platforms.

8. A computing system as recited in 1, further comprising a television-based client device that includes the second device platform and the porting layer that integrates the device-specific application into the television-based client device, the device-specific application having been developed to execute in a different television-based client device that includes the first device platform.

9. A computing system as recited in 1, further comprising a television-based client device that includes the second device platform and the porting layer that integrates the device-specific application with the second device platform to communicate at least one of graphics, events, or state information data communications from the device-specific application to hardware components of the second device platform.

10. A method, comprising:
receiving data communications from an embedded application remoted to a computing system platform with a porting layer, the data communications being received via IP-addressable ports of a socket-based interface and routed through the porting layer; and
transferring the data communications from the porting layer to at least one of a graphics component, an events component, or a state information component of the computing system platform which processes the data communications according to the computing system platform.

11. A method as recited in claim 10, further comprising executing the porting layer as a referenced component of the embedded application to integrate the embedded application with the computing system platform.

12. A method as recited in claim 10, further comprising executing the porting layer as an independent process on the computing system platform to integrate the embedded application with the computing system platform.

13. A method as recited in claim 10, further comprising executing the porting layer as a remote process to integrate the embedded application with the computing system platform.

14. A method as recited in claim 10, wherein receiving the data communications includes receiving at least one of graphics, events, or state information data communications which are independently addressable via different IP-addressable ports of the socket-based interface.

15. A method as recited in claim 10, further comprising implementing the porting layer to remote the embedded application on one or more different computing system platforms.

16. One or more computer readable media comprising computer executable instructions that, when executed, direct a television-based client device to:
execute an embedded client application that is configured to implement the television-based client device in an IP-based television system, the embedded client application remoted onto a platform of the television-based client device after having been developed for a different television-based client device having a different platform configuration;
receive data communications from the embedded client application via a socket-based interface and a porting layer that integrates the embedded client application with the platform of the television-based client device, the embedded client application addressing the data communications to one or more IP-addressable ports of the socket-based interface.

17. One or more computer readable media as recited in claim 16, further comprising computer executable instructions that, when executed, direct the television-based client device to execute the porting layer as a referenced component of the embedded client application to remote the embedded client application onto the platform of the television-based client device.

18. One or more computer readable media as recited in claim 16, further comprising computer executable instructions that, when executed, direct the television-based client device to execute the porting layer as an independent process to remote the embedded client application onto the platform of the television-based client device.

19. One or more computer readable media as recited in claim 16, further comprising computer executable instructions that, when executed, direct the television-based client device to receive the data communications from the embedded client application via a communications network that couples the television-based client device and a remote computing device that executes the porting layer.

20. One or more computer readable media as recited in claim 16, further comprising computer executable instructions that, when executed, direct the television-based client device to process the data communications from the embedded client application with at least one of a graphics component, an events component, or a state information component.
